(19) United States
(12) Patent Application Publication
(10) Pub. No.: US 2018/0104866 A1
(43) Pub. Date: Apr. 19, 2018

(54) TARGETED HEATING PAD

(71) Applicant: GM GLOBAL TECHNOLOGY OPERATIONS LLC, Detroit, MI (US)

(72) Inventors: John N. Owens, Franklin, MI (US); Pei-Chung Wang, Troy, MI (US)

(73) Assignee: GM GLOBAL TECHNOLOGY OPERATIONS LLC, Detroit, MI (US)

(21) Appl. No.: 15/296,496

(22) Filed: Oct. 18, 2016

(51) Int. Cl. B29C 35/08; H05B 6/10; B29C 43/02

(52) U.S. Cl. CPC B29C 35/0805; H05B 6/105; B29K 2995/0013; B29C 2035/0811; B29C 43/02

(57) ABSTRACT

A heating apparatus is provided, and includes a blank and a heating pad in contact with one side of the blank. The heating pad has, or is formed from, a first base matrix. A first region of conductive particles is dispersed within the first base matrix, and a second region of conductive particles is dispersed within the first base matrix. An induction heater is configured to inductively heat the conductive particles within the heating pad. The first region of conductive particles is heated to a first temperature and the second region of conductive particles is heated to a second temperature, which is greater than the first temperature.

### INTRODUCTION

This disclosure generally relates to heating of materials for subsequent processing, such as compression molding. Compression molding is a closed mold process in which materials, such as plastics, composites, or metals, are formed via application of pressure within the mold. The process may be used for creating complex shapes from composites.

### SUMMARY

A heating apparatus or manufacturing system is provided. The heating apparatus includes a blank and a heating pad in contact with one side of the blank. The heating pad has, or is formed from, a first base matrix. A first region of conductive particles is dispersed within the first base matrix, and a second region of conductive particles is dispersed within the first base matrix.

An induction heater is configured to inductively heat the conductive particles within the heating pad. The first region of conductive particles is heated to a first temperature and the second region of conductive particles is heated to a second temperature, which is greater than the first temperature.

In some configurations of the heating apparatus, the blank includes a first thickness and a second thickness, which is greater than the first thickness. Therefore, the second region of conductive particles of the first heating pad may be located adjacent the second thickness of the blank, such that the greater temperature of the second region is adjacent the second thickness.

In some configurations of the heating apparatus, the conductive particles of the first region have a first conductivity, and the conductive particles of the second region have a second conductivity, greater than the first conductivity. The conductivity difference may be due to particle density, shape, or material.

The blank of the heating apparatus may be a composite material having a substrate, which is a first thermoplastic, and a filler, which is one of a glass fiber, a carbon fiber, and an aramid fiber. In some configurations, the first base matrix of the first heating pad is formed from a material having a higher degradation temperature than the first thermoplastic. A method of using the described heating apparatuses is also provided.

The above features and advantages, and other features and advantages, of the present subject matter are readily apparent from the following detailed description of some of the best modes and other embodiments for carrying out the disclosed structures, methods, or both.

### BRIEF DESCRIPTION OF THE DRAWINGS

FIG. 1 is a schematic side view or diagrammatic view of a manufacturing system for molding plastic, thermoplastic, or thermoplastic composite parts.

FIG. 2 is a schematic side view or diagrammatic view of a blank and heating pads or mats used with the manufacturing system of FIG. 1.

FIG. 3 is a schematic detail view or diagrammatic view of a portion of the blank and heating pads shown in FIG. 2.

FIG. 4 is a schematic detail view or diagrammatic view of another blank and heating pads, which may also be used with manufacturing systems similar to that show in FIG. 1.

### DETAILED DESCRIPTION

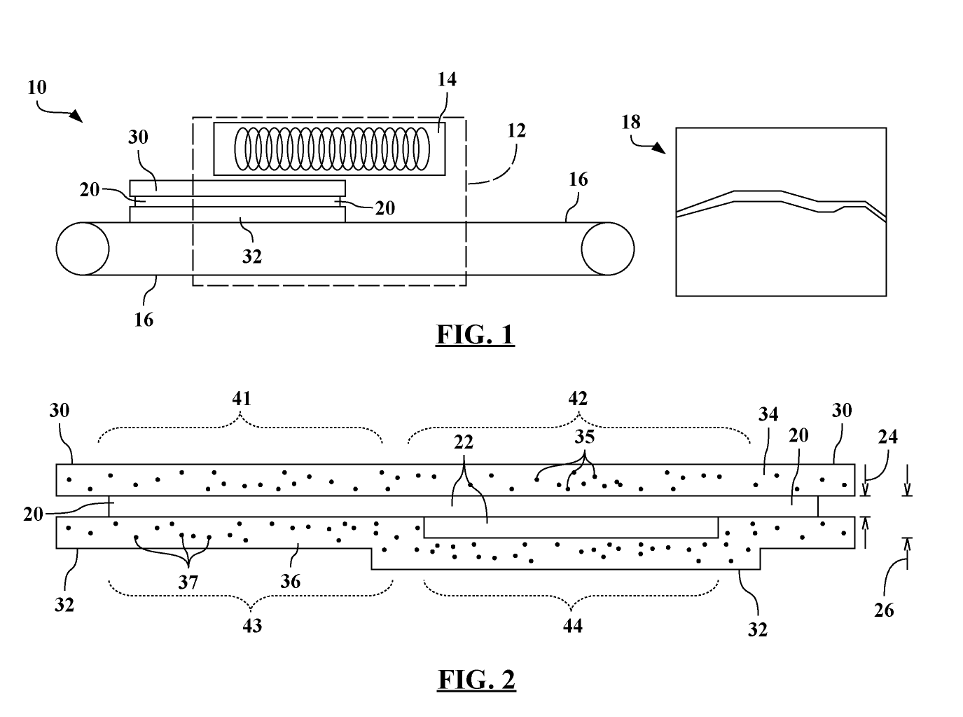

In the drawings, like reference numbers correspond to like or similar components whenever possible throughout the several figures. There is shown in FIG. 1 a schematic manufacturing system 10, which may be used to produce molded plastic, thermoplastic, or thermoplastic composite parts.

While the present disclosure may be described with respect to specific applications or industries, those skilled in the art will recognize the broader applicability of the disclosure. Those having ordinary skill in the art will recognize that terms such as “above,” “below,” “upward,” “downward,” et cetera, are used descriptively of the figures, and do not represent limitations on the scope of the disclosure, as defined by the appended claims. Any numerical designations, such as “first” or “second” are illustrative only and are not intended to limit the scope of the disclosure in any way.

Features shown in one figure may be combined with, substituted for, or modified by, features shown in any of the figures. Unless stated otherwise, no features, elements, or limitations are mutually exclusive of any other features, elements, or limitations. Furthermore, no features, elements, or limitations are absolutely required for operation. Any specific configurations shown in the figures are illustrative only and the specific configurations shown are not limiting of the claims or the description.

The manufacturing system 10 includes a heating apparatus 12, having an induction oven or induction heater 14. The manufacturing system 10 also includes a conveyor 16 and a compression mold 18. The conveyor 16 moves a blank 20 through the heating apparatus 12, where it is heated to a specific temperature or temperature range, before being shaped by the compression mold 18.

The compression mold 18 applies pressure to the heated blank 20 causing portions of the blank 20 to flow within the compression mold 18. In the compression mold 18, the blank 20 is changed from a first shape, which is the unmolded shape, to a second shape, which is the molded part shape and may be at, or near, a final part shape from the manufacturing system 10.

The molded part is released after the compression ends, and may include complex shapes or surfaces and multiple regions of different thickness. Some cooling generally occurs within the compression mold 18, such that the blank 20, which is now formed into the molded part, is reduced to below its melting temperature within the compression mold 18.

Referring also to FIG. 2, and with continued reference to FIG. 1, there is shown a more-detailed view of the blank 20, and associated components, within a portion of the manufacturing system 10. Note that the figures are schematic and diagrammatic only, and that the sizes of components relative to one another may be overstated to better illustrate or identify different features of the manufacturing system 10.

The blank 20 may be formed from a one or more layers 22. In some configurations, the blank 20 may have a single layer 22 with variable thicknesses. Alternatively, as shown in FIG. 2 the blank 20 may have multiple layers 22, which create variable thicknesses.

Whether the blank 20 has one layer 22 or a plurality of layers 22, it may include multiple thicknesses. A first portion of the blank 20 has a first thickness 24 and a second portion of the blank 20 has a second thickness 26, which is larger than the first thickness 24. Note that the first thickness 24 and the second thickness 26 may be denoted as dimensions in the figures.

The areas of greater thicknesses of the blank 20 may be used to thicken, stiffen, or reinforce areas of the molded part to be produced from the blank 20. However, in order to achieve consistent heating of the different thicknesses of the blank 20, additional heat energy is required in the second thickness 26, relative to the first thickness 24, due to the increased amount of material located at the second thickness 26.

In order to prepare the blank 20 for the compression mold 18, the entire blank 20 is heated to within a common temperature or temperature range. In many configurations of the manufacturing system 10, the blank 20 needs to be heated to within a specific temperature range for the compression molding process.

If portions of the blank 20 are not sufficiently heated, the blank 20 may not flow properly to fill the compression mold 18 during the molding process. However, if portions of the blank 20 are over heated, the material may break down or degrade, limiting the integrity of the molded part. Furthermore, because cooling occurs in the compression mold 18, the temperature of the blank 20 is configured to be ready for substantially immediate molding.

In the heating apparatus 12 shown, the blank 20 may be a composite material having a first thermoplastic substrate and a filler. For example, and without limitation, the blank 20 may be formed from a thermoplastic substrate of polypropylene or nylon. The substrate of the blank may be either semi-crystalline or amorphous thermoplastic. In some configurations, the filler material may be one of a glass fiber, a carbon fiber, and an aramid fiber. Note that the substrate and the filler of the blank 20 are not separately identified in the figures.

Exemplary blanks 20 may be, without limitation, long fiber reinforced thermoplastics (LFT) and glass fiber mat reinforced thermoplastics (GMT). Furthermore, the blank 20 may include composite thermoplastics having unidirectional tapes, woven fabrics, or randomly orientated fiber mats incorporated therein.

To prepare the blank for the compression molding process, it is brought to within the specific temperature range, depending on the type of thermoplastic forming the substrate of the blank 20. For semi-crystalline thermoplastic, the specific temperature range is above the polymer's melting point but not below its degradation onset temperature. Semi-crystalline thermoplastics include nylons, polypropylene, and polyethylene.

For amorphous thermoplastics, the glass-transition temperature operates as a minimum, but exemplary systems may use a minimum that is above the glass-transition temperature to promote flow in the compression mold 18. For example, some amorphous thermoplastics would be heated to at least 40 or 50 degrees above the glass-transition temperature, as flowability gradually increases. However, the upper end of the specific temperature range would still be the degradation onset temperature.

In many configurations of the manufacturing system 10, and methods based thereupon, the target temperature may be close to, but without exceeding, the degradation temperature of the thermoplastic substrate. However, the thermoplastic substrate of the blank 20 will be heated to a temperature above its melting point for semi-crystalline polymers or above its glass-transition for amorphous polymers but, in both cases, below the thermal degradation temperature.

However, because the blank 20 has multiple thicknesses, it may be difficult to bring the entire blank 20 into the common or specific temperature range, without portions of the blank 20 being over or under, in a traditional oven, such as a convection or radiation (infrared) oven. The heating apparatus 12 includes structures configured to target additional heat to areas of the blank 20 needing additional heat energy.

A first heating pad 30 is in contact with a first side of the blank 20. The first heating pad 30 may be shaped or contoured, and may also be flexible, to closely align with and contact the different shapes and curves of the blank 20. In the configuration shown, a second heating pad 32 is also in contact with a second side of the blank 20, opposite the first side of the blank 20. However, some configurations may utilize only the first heating pad 30.

As viewed in FIG. 2, the first heating pad 30 is formed from a first base matrix 34 and a plurality of first conductive particles 35 dispersed within the first base matrix 34. As used herein, matrix refers to a material or structure in which something, such as the conductive particles, is enclosed or embedded The second heating pad 32 is formed from a second base matrix 36 and a plurality of second conductive particles 37 dispersed within the second base matrix 36.

The first conductive particles 35 and the second conductive particles 37 may be generically referred to as conductive particles. Different types, and configurations, of the conductive particles may be used. The conductive particles, and regions or areas thereof, are illustrated diagrammatically in the figures.

The first heating pad 30 includes a first region 41 of conductive particles dispersed within the within the first base matrix 34, and a second region 42 of conductive particles dispersed within the first base matrix 34. Similarly, the second heating pad 32 includes a third region 43 of conductive particles dispersed within the second base matrix 36, and a fourth region 44 of conductive particles dispersed within the second base matrix 36.

The induction heater 14 is configured to inductively heat the conductive particles within the first heating pad 30. The first region 41 of conductive particles is heated to a first temperature and the second region 42 of conductive particles is heated to a second temperature, which is greater than the first temperature.

Therefore, different portions of the first heating pad 30 are heated to different temperatures, such that the temperature of the first heating pad 30 is targeted relative to portions of the blank 20. Similarly, in the second heating pad 32, the third region 43 of conductive particles is heated to a third temperature and the fourth region 44 of conductive particles is heated to a fourth temperature, greater than the third temperature.

The heated blank 20 may then be moved to the compression mold 18, via robotics or other mechanisms, including hand carrying. In some configurations, one or more of the first heating pad 30 and the second heating pad 32 may be used for support as the blank 20 is moved or carried to the compression mold 18.

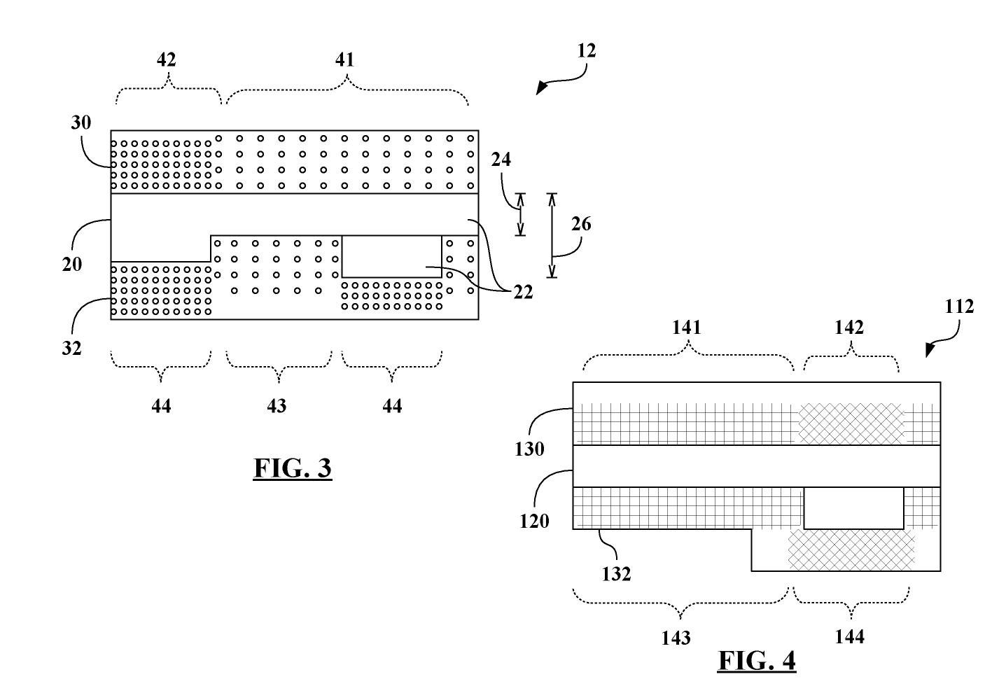

Referring also to FIG. 3, and with continued reference to FIGS. 1-2, there is show a detail view of portions of the blank 20, the first heating pad 30, and the second heating pad 32. FIG. 3 illustrates the blank 20 having at least the first thickness 24 and the second thickness 26. Additionally, portions of the blank 20 have greater thickness within a single layer 22 and portions have greater thickness due to multiple layers 22.

In the configuration shown in FIG. 3, the second region 42 of the conductive particles is adjacent the second thickness 26 of the blank 20. Therefore, the higher temperature produced by the second region 42 is capable of heating the additional volume of the second thickness 26 faster than it would if the first heating pad 30 had evenly-dispersed heating characteristics.

The portion of the blank 20 illustrated schematically in FIG. 3, has thick portions of a single layer 22 and also has a region with two layers 22. As illustrated schematically in FIG. 3, the conductive particles of the first region 41 and the third region 43 are dispersed at a first density. However, the conductive particles of the second region 42 and the fourth region 44 are dispersed at a second density, which is greater than the first density.

The different densities of the particles yield different heating rates of the areas in which the particles are disposed, which results in targeted portions of the first heating pad 30 being heated to different temperatures. The greater density of the second region 42 results in higher temperatures within the second region 42 relative to the first region 41 of the first heating pad 30.

In the configuration of the heating apparatus 12 shown, the second thickness 26 of the blank 20 may be at least twice the first thickness 24, such that it requires more heat energy to bring that portion of the blank 20 to the proper temperature or temperature range. Therefore, the second region 42 of the conductive particles is adjacent the second thickness 26 of the blank 20, so that the second region 42 delivers additional heat energy into the second thickness 26 of the blank 20.

In the configuration shown, the fourth region 44 of conductive particles is also adjacent the second thickness 26 of the blank 20, such that the second region 42 and the fourth region 44 are providing additional heat from both sides of the blank 20. However, based on the shape and thickness of the blank 20, additional heating may only be needed from either the first heating pad 30 or the second heating pad 32—i.e., from only one side of the blank 20, as opposed to both sides.

In one example of the heating apparatus 12, the first base matrix 34 and the second base matrix 36 of the first heating pad 30 and the second heating pad 32, respectively, may be formed from a second thermoplastic polymer or from a thermoset polymer. For example, the first base matrix 34 of the first heating pad 30 or the second base matrix 36 of the second heating pad 32 may be polytetrafluoroethylene (PTFE), which is a thermoplastic. Alternatively, the first base matrix 34 and the second base matrix 36 may be a castable silicone rubber, which is a thermoset resin.

In general, the material of the first base matrix 34 and the second base matrix 36 will be non-conducting and temperature resistant so it can heat the blank 20 material hundreds of times. Thermoset polymers may have higher temperature limits and, because they start out as liquids, may promote or facilitate the initial mixing and targeted dispersal of the various regions of the first conductive particles 35 and the second conductive particles 37 within the first heating pad 30 and the second heating pad 32, respectively.

The first thermoplastic forming the substrate of the blank 20 may be, for example, polypropylene or nylon. The second thermoplastic forming the base matrix of first heating pad 30 and the second heating pad 32 may have a higher melting temperature than the first thermoplastic that forms the blank 20. Therefore, the first heating pad 30 and the second heating pad 32 can be heated to higher temperatures than the blank 20 without reaching the decomposition or degradation temperature of the blank 20.

Referring also to FIG. 4, and with continued reference to FIGS. 1-3, there is show a detail view of a portion of a heating apparatus 112, similar to that illustrated in FIGS. 1-3. The heating apparatus 112 includes of a blank 120, a first heating pad 130, and a second heating pad 132, which may be portions of a heating apparatus similar to that illustrated in FIGS. 1-3.

In the heating apparatus 112, a first region 141 of conductive particles within the first heating pad 130 have a first conductivity, and a second region 42 have a second conductivity, which is greater than the first conductivity. Similarly, a third region 143 of conductive particles within the second heating pad 132 have a third conductivity, and a fourth region 144 have a fourth conductivity, which is greater than the third conductivity.

For the heating apparatus 12 shown in FIGS. 2-3, the first heating pad 30 and the second heating pad 32, the different regions of heating were provided via different particle density. However, in the heating apparatus 112, the different regions of heating were provided via different conductivity of the particles. For example, and without limitation, the particles of the first region 141 and the third region 143 may be formed from aluminum, which has a first conductivity, and the particles of the second region 142 and the fourth region 144 may be formed from copper, which has a second conductivity that is greater than the conductivity of aluminum.

Without varying the density of the particles, the second region 142 and the fourth region 144 are heated to greater temperatures than the first region 141 and the third region 143. Therefore, the portions of the blank 120 adjacent the second region 142 and the fourth region 144 receive greater heat energy, even though the particle density may be very similar between the regions.

Conductivity may also be varied with particle shape. For example, the particles within the fourth region 144 may have a shape that is more conducive to induction heating than the shape of the particles within the third region 143. Particle shape, generally, affects conductivity by varying the ability of eddy currents to occur within the particles.

There may also be a method for heating the blank 20, the blank 120, or other related structures. For illustration, the method will be described with reference to the blank 20 and the manufacturing system 10.

The method includes placing the blank 20 in contact with at least one heating pad, such as the first heating pad 30, and passing the blank 20 and the first heating pad 30 through an induction oven, such as the induction heater 14. The first heating pad 30 includes at least two different regions of conductive particles, such as the first region 41 and the second region 42, having at least two different conductivities.

Therefore, the first region 41 of conductive particles within the first heating pad 30 is heated to a first temperature and the second region 42 of conductive particles within the first heating pad 30 is heated to a second temperature, greater than the first temperature.

The method may also include placing the second heating pad 32 in contact with the blank 20, opposite the first heating pad 30. Similarly, the second heating pad 32 may have different regions of conductive particles that heat portions of the second heating pad 32 to different temperatures.

The blank 20 is heated into a specific temperature range, which is generally between the melt temperature and the decomposition or degradation temperature, for semi-crystalline thermoplastics, and between the glass-transition temperature and the decomposition or degradation onset temperature, for amorphous thermoplastics. The heated blank 20 is then removed from the induction heater 14 and moved to the compression mold 18.

The blank 20, still heated to the specific range, is compression molded in the compression mold 18 to its complex, molded shape. Cooling occurs within the compression mold 18, such that the blank 20, which is now formed into the molded part, is reduced to below its melting temperature within the compression mold 18 and its shape is generally stable after removal from the compression mold 18. Post-processing may include additional finishing processes, such as, trimming, boring, milling, or painting.

The detailed description and the drawings or figures are supportive and descriptive of the subject matter discussed herein. While some of the best modes and other embodiments for have been described in detail, various alternative designs, configurations, and embodiments exist.

What is claimed is:

1. A heating apparatus, comprising:
a blank;
a first heating pad in contact with a first side of the blank, the first heating pad having:
a first base matrix;
a first region of conductive particles dispersed within the first base matrix; and
a second region of conductive particles dispersed within the first base matrix; and
an induction heater configured to inductively heat the conductive particles within the first heating pad, wherein the first region of conductive particles is heated to a first temperature and the second region of conductive particles is heated to a second temperature, greater than the first temperature.

2. The heating apparatus of claim 1,
wherein the blank includes a first thickness and a second thickness, greater than the first thickness; and
wherein the second region of conductive particles of the first heating pad is adjacent the second thickness of the blank.

3. The heating apparatus of claim 2, further comprising:
a second heating pad in contact with a second side of the blank, opposite the first side of the blank, the second heating pad having:
a second base matrix;
a third region of conductive particles dispersed within the second base matrix;
a fourth region of conductive particles dispersed within the second base matrix; and
wherein the third region of conductive particles is heated to a third temperature and the fourth region of conductive particles is heated to a fourth temperature, greater than the third temperature.

4. The heating apparatus of claim 3,
wherein the conductive particles of the first region and the third region are dispersed at a first density; and
wherein the conductive particles of the second region and the fourth region are dispersed at a second density, greater than the first density.

5. The heating apparatus of claim 4,
wherein the second thickness of the blank is at least twice the first thickness; and
wherein the fourth region of conductive particles is adjacent the second thickness of the blank.

6. The heating apparatus of claim 5,
wherein the blank is a composite material having a substrate, which is a first thermoplastic, and a filler, which is one of a glass fiber, a carbon fiber, and an aramid fiber; and
wherein the first base matrix of the first heating pad and the second base matrix of the second heating pad are formed from one of a second thermoplastic, different from the first thermoplastic, and a thermoset, having a higher degradation temperature than the first thermoplastic.

7. The heating apparatus of claim 2,
wherein the conductive particles of the first region have a first conductivity; and
wherein the conductive particles of the second region have a second conductivity, greater than the first conductivity.

8. The heating apparatus of claim 1,
wherein the blank is a composite material having a substrate, which is a first thermoplastic, and a filler, which is one of a glass fiber, a carbon fiber, and an aramid fiber; and
wherein the first base matrix of the first heating pad is formed from a material having a higher degradation temperature than the first thermoplastic.

9. A method of heating a blank, the method comprising:
providing a blank, wherein the blank is formed from:
a first thermoplastic substrate; and
a filler;
placing the blank in contact with a first heating pad, wherein first heating pad is formed from:
a first base matrix;
a first region of conductive particles dispersed within the first base matrix;
a second region of conductive particles dispersed within the first base matrix, wherein the second region of conductive particles has greater conductivity than the first region of conductive particles; and
passing the blank and the first heating pad through an induction oven, such that the first region of conductive particles is heated to a first temperature and the second region of conductive particles is heated to a second temperature, greater than the first temperature; and
heating the blank to a target temperature range with the first heating pad.

10. The method of claim 9, further comprising:
placing a second heating pad in contact with the blank, opposite the first heating pad, wherein the second heating pad includes:
a second base matrix;
a third region of conductive particles dispersed within the second base matrix; and
a fourth region of conductive particles dispersed within the second base matrix, wherein the fourth region of conductive particles has greater conductivity than the second region of conductive particles.

11. The method of claim 10, further comprising:
removing the blank, heated to the target temperature range, from the induction heater; and
compression molding the blank from a first shape to a second shape, different from the first shape.

12. The method of claim 11, wherein the target temperature range is between a melt temperature and a degradation temperature of the first thermoplastic substrate of the blank.

13. A heating apparatus, comprising:
a blank having a first thickness and a second thickness, greater than the first thickness;
a first heating pad in contact with a first side of the blank, the first heating pad having:
a base matrix;
a first region of conductive particles dispersed within the base matrix, wherein the conductive particles of the first region are dispersed at a first density; and
a second region of conductive particles dispersed within the base matrix, wherein the conductive particles of the second region are dispersed at a second density, greater than the first density, and the second region of conductive particles is adjacent the second thickness of the blank;
a second heating pad in contact with a second side of the blank, opposite the first side of the blank, the second heating pad having:
a second base matrix;
a third region of conductive particles dispersed within the second base matrix;
a fourth region of conductive particles dispersed within the second base matrix; and
an induction heater configured to inductively heat the conductive particles within the first heating pad,
wherein the first region of conductive particles of the first heating pad are heated to a first temperature and the second region of conductive particles is heated to a second temperature, greater than the first temperature, and
wherein the third region of conductive particles of the second heating pad are heated to a third temperature and the fourth region of conductive particles is heated to a fourth temperature, greater than the third temperature.

14. The heating apparatus of claim 13,
wherein the blank is a composite material having a substrate, which is a first thermoplastic, and a filler, which is one of a glass fiber, a carbon fiber, and an aramid fiber; and
wherein the first base matrix of the first heating pad and the second base matrix of the second heating pad are formed from one of:
a second thermoplastic, different from the first thermoplastic, having a higher degradation temperature than the first thermoplastic; and
a thermoset, having a higher degradation temperature than the first thermoplastic.
